(19) United States
(12) Patent Application Publication
(10) Pub. No.: US 2013/0120922 A1
(43) Pub. Date: May 16, 2013

(54) SIDE ACCESS LCD KEYBOARD CONSOLE WITH KVM

(71) Applicant: Chassis Plans, LLC, San Diego, CA (US)

(72) Inventors: Drew Castle, San Diego, CA (US); David Lippincott, San Diego, CA (US)

(73) Assignee: Chassis Plans, LLC, San Diego, CA (US)

(21) Appl. No.: 13/676,023

(22) Filed: Nov. 13, 2012

Related U.S. Application Data
(60) Provisional application No. 61/559,633, filed on Nov. 14, 2011.

(51) Int. Cl. G06F 1/16

(52) U.S. Cl. CPC G06F 1/1601
USPC 361/679.08

(57) ABSTRACT

A side-access KVM module comprising a user console and a KVM switch is adapted for pull-out installation within a server rack, the user console portion comprising a keyboard, video display, and mouse, each of which being oriented for side-access operation. The side-access KVM provides reduced operation space for applications in confined spaces such as military transport vehicles and the like. Moreover, the disclosed embodiments provide for a minimal 1U (1.75 inches) requirement for server rack space.

### CROSS-REFERENCE TO RELATED APPLICATIONS

This application claims benefit of priority with U.S. Provisional Ser. No. 61/559,633, filed Nov. 14, 2011, titled “LOW PROFILE KVM UNIT”; the contents of which are hereby incorporated by reference.

### BACKGROUND OF THE INVENTION

1. Field of the Invention

This invention relates to rack-mounted keyboard-video-mouse (KVM) drawers; and more particularly to a KVM drawer adapted for side access for reduced space operation within confined spaces.

2. Description of the Related Art

Rack-mounted keyboard-video-mouse (KVM) drawers are becoming increasingly popular in various computing applications. Such KVM drawers generally provide a pull-out drawer having a console portion including a video display, keyboard, and mouse for operating one or more servers or CPUs connected therewith. The drawer is pulled out from a standard server rack and the video display is opened at a hinge from a closed position to approximately 110 degrees from horizontal at an open position. In addition, many KVM drawers include a keyboard being mounted beneath the drawer and adapted with sliders for sliding the keyboard out from a home position beneath the drawer to an extended position.

FIG. 1 schematically illustrates a typical KVM drawer according to embodiments of the prior art. The system includes a KVM switch 20 having a plurality of computer ports 23 and at least one console port 24, a plurality of computers 30 each connected to a computer port 23 of the KVM switch 20, and one or more user consoles 10 each connected to a console port 24 of the KVM switch 20 (one user console 10 is shown). The KVM switch 20 includes a switching section 21 that selectively connects one of the computer ports to a console port to allow the user to interact with the selected computer 30 using the user console 10. It also includes a control section 22, which may be implemented as a microcontroller unit or other suitable circuitry, for controlling the functions of the KVM switch 20. The control section 22 may also include a memory (not shown) for storing various data. The switching section 21, as well as other components not shown in FIG. 1 generally have structures known by those having skill in the art of conventional KVM switches, and are not described in further detail here.

The operation of these KVM drawers requires an amount of floor space, or “operation area”, defined by the size of the KVM drawer, the pull-out length associated with the KVM drawer, a volume consumed by the KVM drawer's expanded components, and user seating requirements with the unit in an operational state.

Although the most common use of KVM drawers is within network server-room installations, where adequate space may or may not be limited, rack-mounted KVM modules can also be used in mobile transport applications, for example inside of aircraft, marine vessels, and land vehicles. Moreover, KVM modules are being increasingly incorporated into military transport applications.

However, in the tight confines of such military transport applications including aircraft, marine vessels, and land operated vehicles, there is a need for rack mounted KVM drawers which provide a reduced operation area. Moreover, rack space is often limited in these applications and therefore there is a need for a low-profile rack mounted KVM drawer, and preferably one adapted for a minimum spatial requirement of up to 1 U (1.75 inches).

Moreover, typical KVM drawers and components thereof are not suitable for use in adverse environments such as those environments experienced in military transport applications. Thus, there is a need for improved KVM drawers which account for narrow space requirements, rugged and durable components for use in aggressive and adverse environments, and other considerations relating to military applications.

### SUMMARY OF THE INVENTION

In a preferred embodiment, the invention comprises a keyboard-video-mouse (KVM) drawer comprising a user console portion and a KVM switch, the KVM drawer being adapted for installation within a server rack, and one or more components of the user console being oriented for side-access for reducing the operation space required for operation of the KVM module.

In one embodiment, a switch and LED are mounted on the console portion of the KVM drawer for providing an efficient means for switching between several computers which are connected to the KVM.

In another embodiment, the KVM drawer is further programmed to accept a combination of keys (hot keys) for performing various functions.

In yet another embodiment, the video display comprises a first glass panel with an Indium Tin Oxide (ITO) conductive Electro-Magnetic Interference (EMI) filter and a second glass panel positioned over the first glass panel, the second glass panel having a sputtered anti-reflective coating thereon. In this regard, the display screen is adapted for EMI radiation remediation and anti-reflective ITO for enhancing the contrast and visibility of the display for use in harsh environments.

Other features and embodiments are described in the detailed description herein.

### BRIEF DESCRIPTION OF THE DRAWINGS

FIG. 1 is a schematic of a general KVM module and key components according to various prior art embodiments.

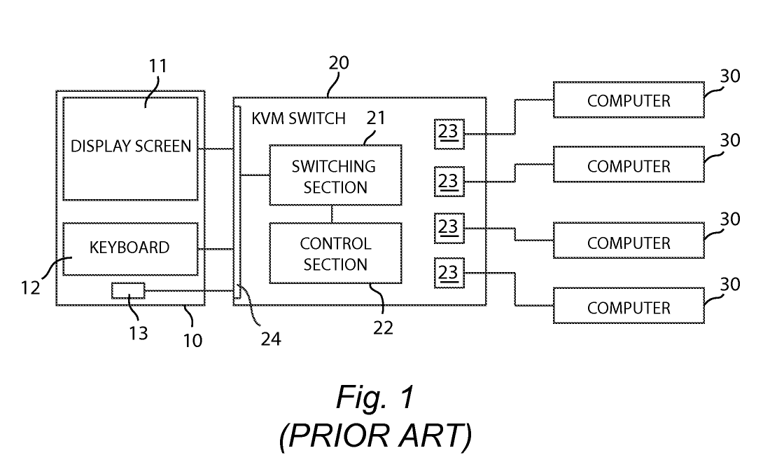

FIG. 2 illustrates a KVM module installed within a server rack according to an embodiment of the invention, the KVM module being adapted for side-access.

FIG. 3 illustrates a front perspective view of the side-access KVM module in an operational state.

FIG. 4 illustrates a front perspective view of the side-access KVM module in a closed state.

FIG. 5 illustrates a side perspective view of the KVM module having a user console and a KVM switch.

FIG. 6 illustrates a rear perspective view of the user console, KVM switch and computer ports thereof according to an embodiment of the invention.

FIG. 7 further illustrates a top view of the side-access KVM module according to various embodiments herein.

### DETAILED DESCRIPTION OF THE PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

In a general aspect of the invention, a side-access KVM drawer adapted for installation within a server rack comprises a user console portion and a KVM switch portion, the user console portion comprising one or more console components selected from a keyboard, video display, and mouse, wherein the console components are each oriented perpendicular with respect to a pull-out axis for providing side-access operation to a user. In this regard, a user is enabled side-access operation of the KVM module for reducing the operation space requirement defined by the KVM module, components, and user space required in an operation mode.

In another aspect of the invention, the KVM module is adapted for server rack installation and comprises a rack profile of up to 1 U (1.75 inches) of standard rack space in a closed configuration.

The KVM module may comprise a drawer portion having a base, a first longitudinal side, a second longitudinal side, and an interior surface of the base. The keyboard may be recessed within the base at the interior surface for reducing the overall thickness or “rack height” of the KVM unit. Additionally, a video display may be hingedly connected to the base at one of said longitudinal sides such that the video display may be adapted for hinged rotation about the one or more hinges. In this regard, the video display can be opened to approximately 110 degrees from horizontal (standard operating position) without requiring additional pull out along a longitudinal axis and thereby minimizing depth of the KVM drawer in an operational state. In certain embodiments, the depth of the KVM drawer is less than twenty five inches.

These and other aspects of the invention are further illustrated in the drawings with reference to at least one preferred embodiment as described below.

For purposes of this invention, we use the terms “KVM drawer” and “KVM module” interchangeably. However, it should be noted that the term “KVM switch” is intended to describe a circuit component within the drawer or module which is adapted to switch connection between any number of computers coupled with the KVM drawer.

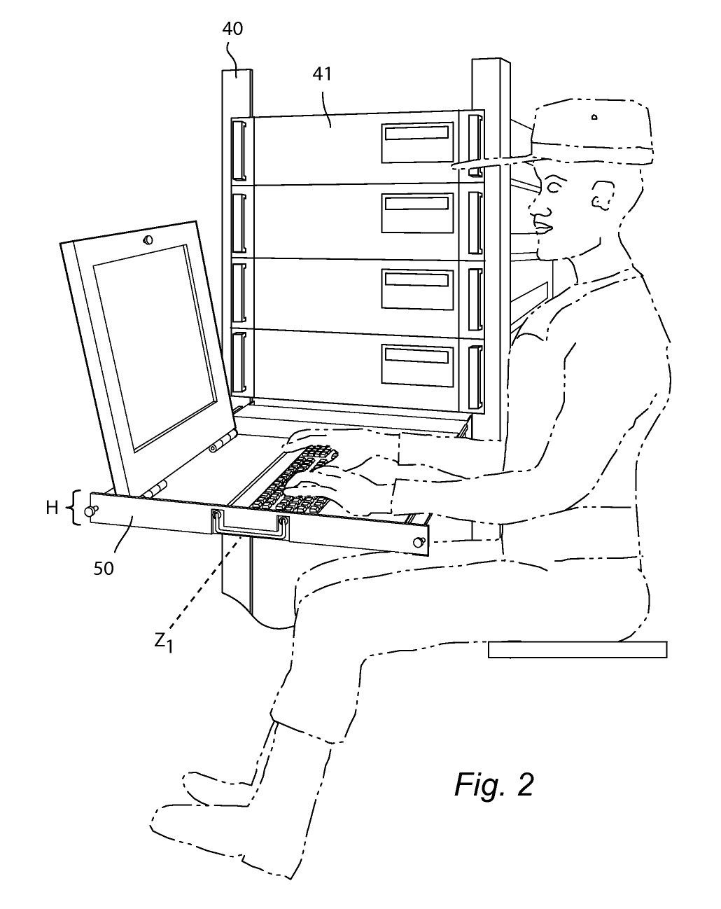

FIG. 2 illustrates a side-access KVM module 50 installed within a server rack 40 and adapted for slideable withdrawal from the rack along a pull-out longitudinal axis (Z₁). One or more computers 41, servers, or related equipment, can be installed within the server rack, and the KVM module is adapted for low profile rack storage with a module height (H) of up to 1 U. As illustrated herein, a user (illustrated by the dashed lines) can position his or her legs beneath the pull-out KVM module and access the user console portion of the KVM module from a side thereof. In this regard, the KVM module can be pulled out from the rack with less depth when compared to a prior art KVM's. Moreover, because the keyboard is housed within the drawer and does not require additional sliders for keyboard pullout, the overall operation space is significantly reduced according to the described side-access orientation.

Although the side access is illustrated as being on a right side of the KVM module, it should be recognized that the KVM module and components thereof can be similarly oriented for providing side access about a left side of the KVM module.

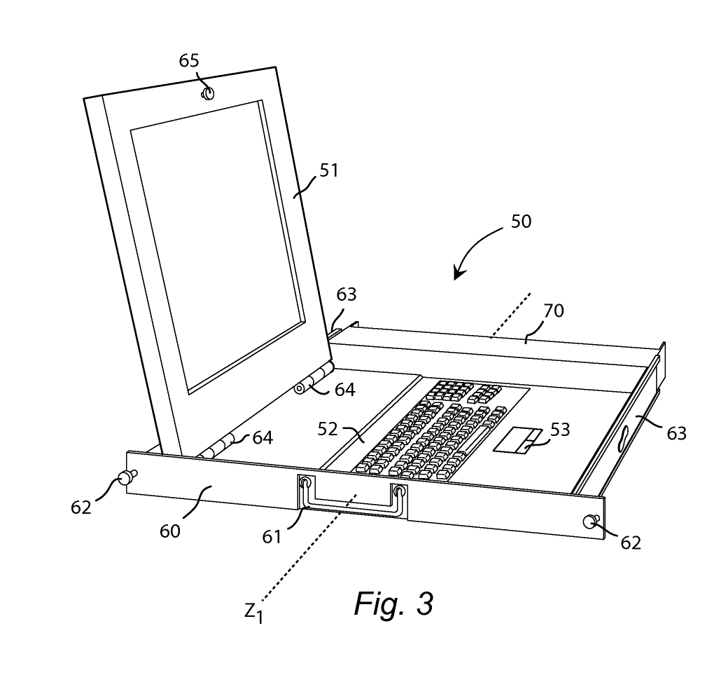

FIG. 3 further illustrates the KVM module of FIG. 2 according to a front perspective view. The KVM module 50 comprises a user console portion including a keyboard 52, a video display 51, and a mouse 53. The KVM module further comprises a KVM switch 70 for connecting one or more computers to the user console.

Although illustrated as a touch-pad style mouse, the mouse 53 can comprise a roller ball, joystick, or other style of mouse for navigating computer software applications. Alternatively, the KVM can comprise no mouse.

The keyboard 52 generally comprises any popularized keyboard style known in the art. The keyboard is recessed and mounted within an interior bottom surface of the drawer. Additionally, the keyboard may include a spill-proof keyboard, such as a monolithic molded structure adapted to repel contaminants such as liquids which may damage the electronics of the keyboard and/or other KVM module components.

The video display 51 is attached to the interior bottom surface of the drawer at one or more hinges 64 disposed along a longitudinal side thereof. The video display may further comprise a locking mechanism 65 attached viewing bezel surface of the video display along a longitudinal top edge for locking the display screen in a closed position for preventing damage of one or more components of the KVM. The locking mechanism 65 can comprise a quarter-turn latch with a bail for securely closing the display and the bail can be used as a finger pull for extending the display to an open viewing position.

The drawer portion generally comprises a front plate 60 having a recessed handle 61 embedded within a front facing surface thereof, and one or more drawer locks 62 for securely locking the drawer in a closed position within the server rack when not in use. The recessed handle reduces the likelihood of catching or snagging items thereon. To meet military specifications, the front plate and other structural components of the KVM drawer can be fabricated from a durable and lightweight aluminum or similar material. The drawer further comprises friction sliders 63 disposed along a first longitudinal side and a second longitudinal side opposite of the first longitudinal side. The friction sliders are adapted to engage with the rack and provide slideable withdrawal from the server rack along the longitudinal pull-out axis (Z₁). It is important to note that ball bearing sliders have been used in prior art KVM drawers, however these ball bearing sliders tend to fail in dusty or otherwise harsh environments. In this regard, the friction sliders described herein provide a durable alternative slider mechanism for permitting use in harsh conditions. Moreover, the friction slides provide resistance along the pull out axis such that the KVM drawer will not easily move or vibrate away from the user.

Each of the keyboard, video display, and mouse components are oriented perpendicular to a longitudinal pull-out axis (Z₁). As described above, this orientation provides a side-access for reduced operation space.

The KVM module as depicted in FIG. 3 is said to be in an operational state, or open configuration. Here the video display is hingedly opened about 110 degrees from a horizontal plane of the drawer. It is important to note that the KVM drawer is only required to be pulled out along the Z1 axis to clear the length of the user console portion and the display. In this regard, prior art KVM drawers require the drawer to be pulled out an additional distance such that the display may be opened to about 110 degrees, this added pull out dimension significantly impedes the operation space required by the KVM. Thus, the side-access KVM drawer as illustrated in FIG. 3 provides a solution to prior art limitations whereby the side-access configuration effectively minimizes the required operation space.

In certain embodiments, the display screen 51 can comprise an EMI filter, an anti-glare coating, or both. For example, in one embodiment the video display comprises a first glass panel with an Indium Tin Oxide (ITO) conductive Electro-Magnetic Interference (EMI) filter and a second glass panel positioned over the first glass panel, the second glass panel having a sputtered anti-reflective coating thereon. In this regard, the display screen is adapted for EMI radiation remediation and anti-reflective ITO for enhancing the contrast and visibility of the display for use in harsh environments. Both of the first and second glass panels can be bonded with the display screen. Moreover, the display can comprise a CCFT fluorescent or LED backlight. Although size is a consideration for each application, the incorporated display screen can be up to nineteen inches.

In one embodiment, the display comprises an industrial quality LCD panel (off the shelf item) and is further processed to enhance the mechanical, optical, and EMI properties of the finished display by optically bonding two layers of coated 1.1 mm soda-lime float glass to the front of the LCD panel. The first layer is coated with an Indium Tin Oxide (ITO) coating with a surface resistivity of <13.5 ohms/sq. The first layer is bonded to the display using an optical index matching adhesive. The second layer of glass is coated with an anti-reflective coating which matches the index of refraction of air to eliminate surface reflections. The second layer is bonded over the first layer using the optical index matching adhesive. A copper conductive buss bar wraps around the edges of the glass to facilitate conduction from the ITO coating to the front surface of the laminated structure to make a complete electrical shield around the face of the LCD. In this regard, the display is adapted to eliminate internal reflections caused by the index of refraction mismatch between the soda lime glass and air. Thus, more than 95% of the unwanted glare is eliminated from the screen.

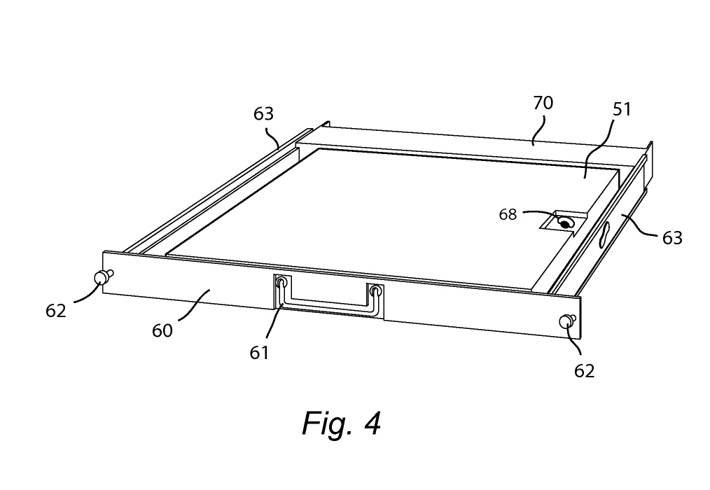

FIG. 4 illustrates the KVM module in a non-operational state, or closed configuration, with the video display 51 hingedly folded downwardly for covering the keyboard and mouse components. In this regard, the drawer 60 is configured for slideably inserting and locking within the server rack. As described above, sliders 63 enable slideable engagement with the server rack. Here, the drawer locks 62 are adapted to engage with the server rack for securely locking the recessed drawer in a storage position. Additionally, a display locking mechanism 68 is shown, the display locking mechanism can comprise a recessed cavity for storing the flip latch within the volume of the display.

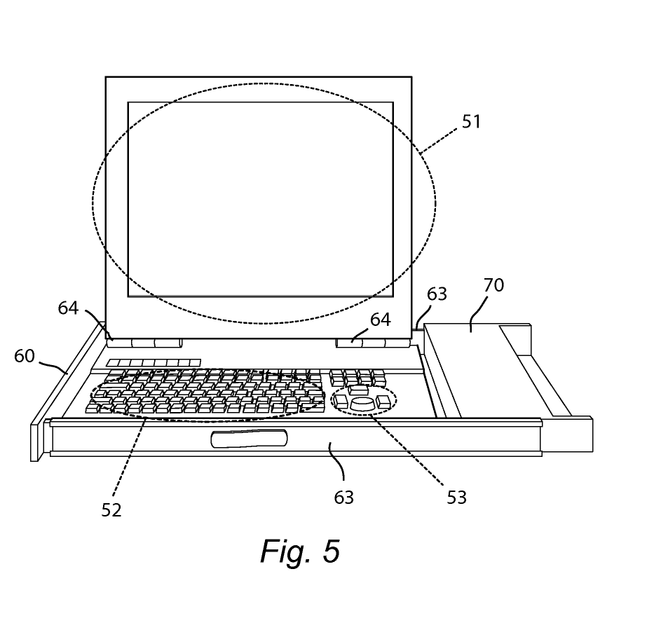

FIG. 5 illustrates a side perspective view of a KVM module according to a preferred embodiment, the KVM module comprising a user console including a flip-open video display 51 attached to an interior drawer surface at one or more hinges 64 disposed along a longitudinal length thereof, a keyboard 52 being recessed within the interior surface of the drawer, and a mouse 53. The KVM further comprises a KVM switch 70 disposed adjacent to the user console along a longitudinal depth of the KVM module. In this regard, only the user console is required to be pulled-out from the server rack during operation, the KVM switch can remain inside the server rack for providing a minimum operation space.

The drawer portion 60 of the KVM module is slideably engaged and mounted with the server rack (not shown) at a pair of sliders 63 each disposed along opposite longitudinal sides of the KVM drawer portion.

The keyboard, video display, and mouse of the KVM module are each oriented perpendicular to a longitudinal pull-out axis for providing a user with side access operation as described above.

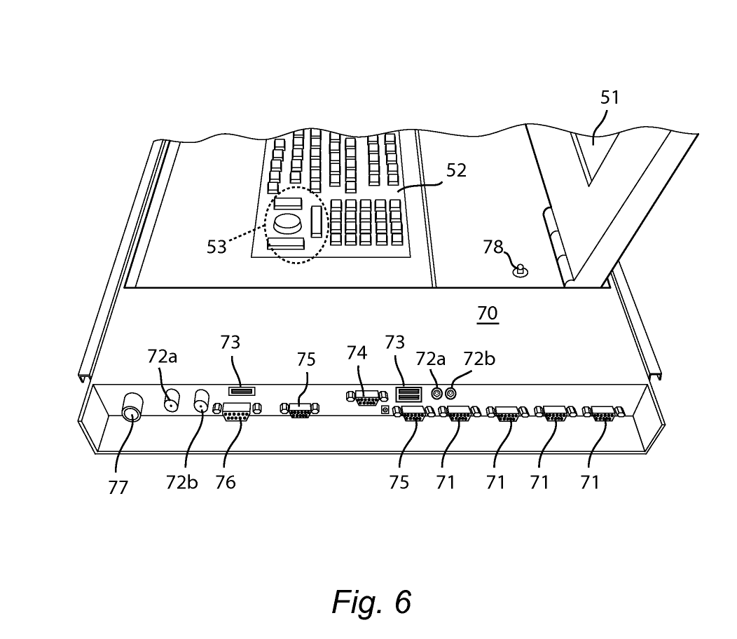

FIG. 6 further illustrates the KVM switch 70 and several components thereof. In one embodiment as illustrated in FIG. 6, the KVM switch 70 comprises four computer ports 71 extending outwardly from a rear side of the drawer. Although four computer ports 71 are illustrated, it should be recognized that any number of computer ports can be incorporated depending on the application. In the illustrated embodiment, the KVM comprises a 4-port switch capable of selectively operating up to four computers. It should be noted that the KVM switch can be daisy-chained to connect up to 256 computers. The KVM switch further comprises. A custom cord can be provided for connecting each of the one or more computers to the several computer ports of the KVM switch. The custom cord can comprise a serial adapter on a first end, and one or more PS/2, USB, and/or VGA adapters on a second end thereof opposite of the first end.

The KVM switch can be programmed to provide OSD control using keyboard hot key commands. In this regard, operating a mouse can be difficult in harsh environments, especially where there is an abundance of vibration, shaking, or other instability. Thus, the hotkey commands provide a mechanism for quickly and efficiently operating the coupled CPU's.

The KVM switch further comprises keyboard and mouse PS/2 ports 72a; 72b and USB ports 73. In addition, the KVM switch can comprise a DVI port 76; VGA ports 75; USB, ports 73; and external power connections. These ports and similar components of the KVM switch are widely known in the art and thus will not be discussed in detail here.

A shut-off switch 78 can be provided on the user console surface such that the display is adapted to activate the push-style switch when closed. The shut-off switch is adapted to shut off the backlight of the display. In this regard, the limited life of the display can be extended by shutting off the backlight when not in use. Additionally, power can be saved by shutting off the backlight.

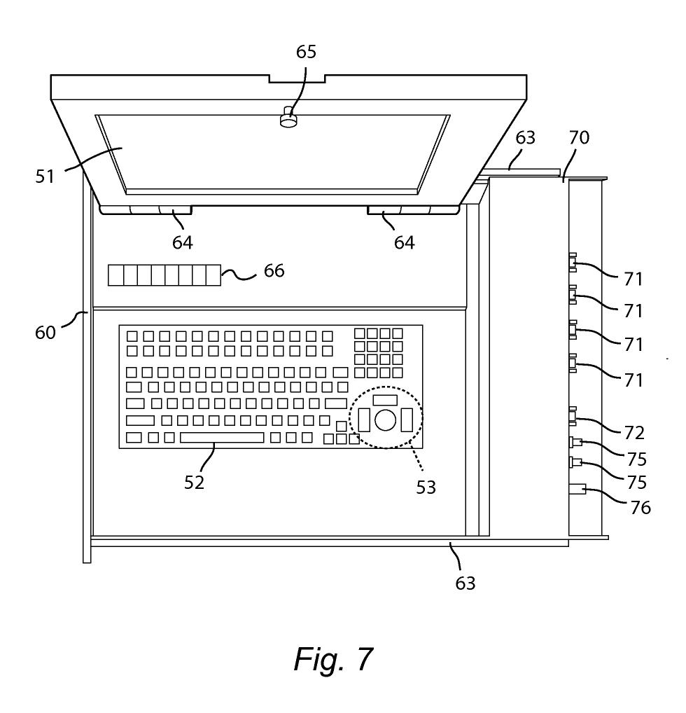

FIG. 7 is a top view of the KVM module in accordance with a preferred embodiment. The KVM module comprises a KVM switch 70 having multiple computer ports 71 and other ports as described above. The KVM module further comprises a user console comprising a video display 51, a keyboard 52, and a mouse 53. The display is connected to the drawer portion at one or more hinges 64 disposed along a longitudinal edge thereof. A hot key pad 66 comprising one or more buttons, switches, or touch sensors, may be further incorporated and disposed along an interior surface of the drawer. The KVM module is adapted to slideably translate in and out of the server rack at the sliders 63 as previously described.

Each of the keyboard, video display, and mouse, of the KVM module are oriented perpendicular with respect to a longitudinal pull-out axis for providing side access to an operator/user. In this regard, reduced operation space is achieved.

Moreover, the recessed keyboard and folding monitor provide a low-profile rack height of 1 U (1.75 inches) for minimizing rack space.

In certain embodiment, each computer port of the KVM switch is numbered, for example one to four. The KVM switch is adapted to switch the keyboard, video display, and mouse between the computer ports for operation of the coupled computers. In one embodiment, a hot key can be used to switch between the computer ports; for example a user can key [SCROLL LOCK] twice, followed by [ENTER] to switch the KVM to a subsequent port. To allow a user to visually determine which port is active on the KVM an LED may be provided on the user console for designating an active computer port. For example, the user console can comprise four LED indicators along an LED strip, each of the four indicators being assigned to a distinct CPU port. As the user switches between ports on the KVM, an LED indicator can light up to inform the user which system is currently being operated. In addition to hot keys, a simple push-button or other switch can be provided on the user console for rapidly switching the KVM between computer ports. In any case, the corresponding LED indicator is adapted to illuminate for indicating the connected computer port to the user.

In another embodiment, a hot key combination can be programmed into the KVM for connecting directly to a desired computer port. For example, the keys [SCROLL LOCK] [SCROLL LOCK] [N] [ENTER], where “N” is an integer between one and four, can be used to quickly call up a desired computer port. As described above, the corresponding LED indicator will indicate port “N” on the user console.

In another embodiment, the KVM is programmed to scan between each computer port, or at least each of the computer ports with an active connection therewith. In this regard, the hot keys [SCROLL LOCK] [SCROLL LOCK] [A] [ENTER] are used. In this regard, the KVM can switch between computer ports at “T” second intervals, for example, wherein “T” is between one and ten seconds, and more preferably “T” is 5 seconds. In certain embodiments, the value for “T” can be configured in a user configuration window to any desired time interval.

In yet another embodiment, the scan interval can be varied using a hot key combination. For example, the keys [SCROLL LOCK] [SCROLL LOCK] [A] [ENTER] [N], wherein “N” is an integer between one and four, can be used to rapidly select a scan interval for switching between computer ports of the KVM. In this regard, each successive N value can provide an increased “T” (in seconds). In one example, the scan interval hotkey combination is entered with N=1, yielding a three second scan interval. In another example, N=2 produces a five second interval. Moreover, N=3 produces a ten second interval, and N=4 produces a twenty second interval. Each of the values for N can be customized in a user-settings or configuration window built into the KVM software.

Other hot keys can be programmed in memory within the KVM drawer for enabling rapid and efficient operation of the KVM and computers coupled therewith.

In another embodiment, the KVM drawer consists essentially of a display and KVM switch. In yet another embodiment, the Drawer consists essentially of a display having two glass panels and a conductive buss bar and the various coatings described above.

It should be further noted that the KVM drawer can be adapted to use an external power supply for providing additional power options, such as commonly available 110 vol/220 VAC, 12 V vehicular power, 28 VDC military vehicular power, and 48 VDC for use in telephone central office installations.

It will be apparent to those skilled in the art that various modifications and variations can be made to the structure of the invention without departing from the spirit and scope as set forth in the appended claims. In view of the forgoing, it is intended that the invention cover such modifications and variations of the described embodiments provided they fall within the scope of the following claims and their equivalents.

I claim:

1. A side-access keyboard-video-mouse (KVM) drawer, comprising:
a drawer portion housing a KVM switch, and a user console;
the user console further comprising a keyboard, video display, and mouse;
the KVM switch adapted to couple the user console with one or more computers coupled therewith; and
the drawer portion comprising sliders to form a retractable drawer for translating in and out of a server rack along a longitudinal pull-out axis;
wherein each of said keyboard, video display, and mouse are individually oriented perpendicular to the longitudinal pull-out axis for providing side-access operation of the KVM drawer.

2. The side-access KVM module of claim 1, said keyboard being recessed within an interior surface of the KVM module.

3. The side-access KVM module of claim 2, said keyboard comprising a spill-proof keyboard.

4. The side access KVM module of claim 1, said video display coupled to a drawer portion at one or more hinges disposed along a longitudinal side thereof.

5. The side-access KVM module of claim 1, wherein said KVM switch is disposed adjacent to said user console within a common drawer plane.

6. The side-access KVM module of claim 5, said KVM switch comprising one or more computer ports extending outwardly from a rear side of the KVM module.

7. A keyboard-video-mouse (KVM) drawer adapted to pull out from a server rack along a longitudinal pull out axis, the KVM drawer comprising: a keyboard, video display, and mouse collectively defining a user console, and further comprising a KVM switch for connecting one or more computers to said user console; wherein said user console is oriented perpendicular to a longitudinal pull-out axis.

8. The KVM module of claim 7 comprising a rack height of not more than 1 U.

9. A keyboard-video-mouse (KVM) system, comprising:
a drawer portion adapted for slideable engagement with a server rack, the drawer portion comprising a base having an interior surface and a recessed portion thereof, a first friction slider disposed along a first longitudinal side, a second friction slider disposed along a second longitudinal side, a front end, and a back end;
a keyboard at least partially received in said recessed portion of the drawer;
a video display coupled to said drawer at said first longitudinal side along a longitudinal edge thereof using one or more hinges;
a mouse; and
a KVM switch adapted to connect said keyboard, video display, and mouse to one or more computers;
wherein each of said keyboard, video display, and mouse are individually oriented perpendicular to a longitudinal pull-out axis for providing side access and reducing operation area associated with the use of the KVM module.

10. The KVM module of claim 9 having a rack height of 1 U.
